(19) United States
(12) Patent Application Publication
(10) Pub. No.: US 2010/0281352 A1
(43) Pub. Date: Nov. 4, 2010

(54) INTERNET-BASED INFORMATION SYSTEM AND METHOD FOR ASCERTAINING A DATA-RECIPIENT-SPECIFIC DATA RECORD

(75) Inventor: Michael Mohr, Berg (DE)

Correspondence Address: KATTEN MUCHIN ROSENMAN LLP, 575 MADISON AVENUE, NEW YORK, NY, 10022-2585, US

(73) Assignee: DCI DATABASE FOR COMMERCE AND INDUSTRY AG, Stamberg (DE)

(21) Appl. No.: 12/682,130

(22) PCT Filed: Oct. 7, 2008
(86) PCT No.: PCT/EP08/08441

§ 371 Date: Jul. 20, 2010

(30) Foreign Application Priority Data
Oct. 9, 2007 (DE) 10 2007 048 380.7

(51) Int. Cl. G06F 15/16; G06F 17/00

(52) U.S. Cl. 715/205; 709/206

(57) ABSTRACT

An internet-based information system for selectively presenting data e-mails (8) from a multiplicity of data providers (X, Y), said presentation being able to be called up for a multiplicity of data recipients (E), comprises a central information server (1) having an e-mail interface unit (4), a web interface unit (10), a memory device (6), which has at least one supply memory unit (7) for storing data e-mails (8) from the data providers (X, Y), and a selection device (13), a multiplicity of data processing installations (2), which are respectively associated with a provider (X, Y) and which have an e-mail interface (5_{X}, 5_{Y}) which is capable of communicating with at least one provider-specific e-mail address (4_{X,A}, 4_{X,B}, 4_{Y,B}, 4_{Y,C}) for the e-mail interface unit (4) of the central information server (1), and a multiplicity of portal servers (3), which respectively have a web interface (11_{A}, 11_{B}, 11_{C}) and which can be connected to the web interface unit (10) of the central information server (1). In this case, the portal servers (3) have access to specific data e-mails (8_{X,A}, 8_{X,B}, 8_{Y,B}, 8_{Y,C}) which are stored in the supply memory unit (7) and which are automatically ascertained by the selection device (13) on the basis of the identity of the respective portal server (3_{A}, 3_{B}, 3_{C}), and are then able to present these data via a link on a homepage (16_{A}, 16_{B}, 16_{C}), wherein the central information server (1) also has a hyperlink-identification and manipulation device (17) which can be used to automatically identify hyperlinks (18) which are present within the data e-mails (8) and to automatically manipulate said hyperlinks such that selection of a manipulated hyperlink (19) which is present in a data e-mail (8) presented via a portal server (3) first of all triggers an interrogation routine (20) for ascertaining a data-recipient-specific data record (21), the data recipient (E) being forwarded to the URL of the hyperlink (18) originally present in the data e-mail only when the interrogation routine (20) has been successfully terminated.

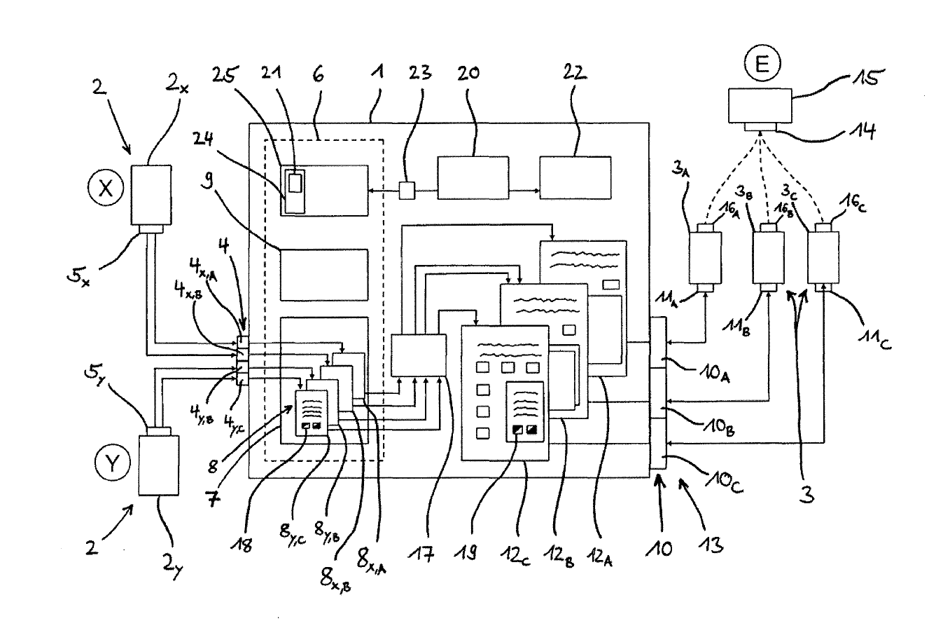

The present invention concerns an internet-based information system according to the preamble of claim 1 as well as a method for ascertaining of data-recipient-specific data record.

Such an internet-based information system is known from prior art and described in WO 2005/091184 Al, which, in its entirety, is the subject of the present disclosure. This system, which primarily depends on the provision and the interaction, to be subsequently explained in more detail, of a central information server with a plurality of portal servers, is characterized among other things in that the most varied data e-mails (with advertising, current offers or other information or data) from a plurality of data providers can be made accessible to a plurality of data recipients by simple means and completely automated via a portal server. To this end a data provider has to simply send his data e-mails to an e-mail address that has been assigned to him, meaning it is a provider-specific e-mail address of an e-mail interface unit of a central information server. A plurality of provider-specific e-mail addresses can also be assigned per data provider. The data e-mails of the plurality of data providers are stored in a memory unit of the central information server and can be presented by selected portal servers by means of a suitable link on their web page or homepage, whereby a portal-specific access control in regard to the data e-mails is provided with the assistance of a selection device of the central information server. The presentation of the data e-mails is implemented on the home page or within the internet offering of the respective portal server by means of a link, which is suitably integrated into the internet offering, to a portal-specific URL of a web interface unit of the central information server, whereby the respective URL is assigned a web page (generated dynamically by the central information server) for the purpose of the display of the data e-mails.

The data providers thereby obtain from the operator of the central information server by particularly simple means the opportunity to “push” up-to-the-minute contents in the form of easily assembled data e-mails into the internet offerings of selected portal servers. The data e-mails can be drawn up in all current e-mail formats (for example HTML-standard or as plain text) and, as the case may also contain scripts and/or files of different formats, such as for example pdf-files, common graphics-, audio-, video- or other media contents that are to be presented via the portal server. The web pages that are generated dynamically by the central information server permit the processing of the different e-mail- and data formats and their presentation via the internet offering of the portal server. If applicable, an automatic data conversion can also occur in this case by, for example, converting data, which was sent by the data providers to the central information server, of a certain format for the purpose of their presentation via the portal server into a different data format. Thereby the most varied video formats can, for example, be converted into so-called flash-video; a conversion of pdf-files into a flash format can also be provided, just to mention a few examples. In this context it is particularly also possible for the data providers to integrate into their e-mails any hyperlinks so specific web pages, particularly web pages of their own internet offerings, so that the data recipients have the opportunity during the perusal of a data e-mail—represented by a portal server—to be immediately directed to the URL of the linked web page by selection of a hyperlink (which is usually accomplished by “clicking” the hyperlink that is presented to the data recipient in the form of a text- or graphics element).

The data recipients who are theme- or content-specifically addressed by the portal servers can view the data e-mails that contain for example offers or advertising without having to plug-up—such as for example by subscribing to corresponding newsletters—their own e-mail account with an, as the case may be, undesired flood of e-mails. In addition they can participate anonymously in the particular system, provided they do not, on their own initiative, register with the operator of the central information server or with the operator of the utilized portal server—if the respective system permits or requires this.

Data providers, portal server operators and/or the operator of the central information server are however frequently interested in obtaining more precise information, in the form of data recipient-specific data sets, on the identity and/or other characteristics of the data recipients that are interested in their (internet-) offerings or data e-mails. With the existing system and the current concepts of the user registration this is not possible to the desired extent or only with extensive effort. It is to be noted that an implementation of current concepts of the user registration on the part of the data providers and/or the portal server operator requires not only significant effort but is frequently also not desired since in the case of an obligatory user registration a part of the addressed social circles (data recipients) would be excluded de facto from the respective offer as only a few data recipients are willing, when utilizing common internet offerings of the portal servers, to emerge from anonymity.

With this background in mind it is object of the present invention to provide, with a system of this kind, an additional value in the form of a user friendly opportunity, which can be simply implemented, for the determination of a data recipient-specific data set, namely without lowering the performance targets of the information system.

The object is met with an internet-based information system according to claim 1.

The system according to the invention distinguishes itself as a supplement to the already known system of the type mentioned above in that the central information server features additionally a hyperlink recognition and manipulation device by means of which hyperlinks that are present within the data e-mails that are sent by the data providers are automatically recognizable and automatically manipulatable in such a manner that a selection of a hyperlink that is presented and manipulated within a data e-mail, which is presented via a portal server, triggers initially a request routine for the determination of data recipient-specific data set, whereby the data recipient is only directed on to the URL of the hyperlink that was originally present in the data e-mail, if a request routine was successfully completed.

To start it is to be stated in this case that all offerings of the respective portal servers as well as access to all accessible data e-mails of the respective portal servers via the respective portal server are accessible by the usual means to a data recipient in a system according to the invention—without the data recipient having to emerge for this purpose from anonymity through the disclosure of a data set that concerns him.

The request routine—generated automatically by a corresponding request routine generator—for the determination of a data recipient-specific data set is only automatically initiated in the event that the data recipient, by means of selection of a manipulated hyperlink in a data e-mail that was presented to him via the portal server, signals further interest in the specific internet offering that was linked by a data provider with his data e-mail. With the hyperlink recognition and manipulation device hyperlinks originally present within data e-mails of different data providers are recognized for this purpose and manipulated via a portal server in such a manner, prior to the presentation of the particular data e-mail, that the data recipient as a result of the selection of the manipulated hyperlink is not immediately directed to the URL originally linked to the hyperlink, but such a redirection is only implemented after the successful completion of the request routine. The successful completion is understood to mean that the data recipient-specific data record, which was to be determined, was successfully determined.

It proves to be of a particular advantage in the case of the system according to the invention that for the determination of the data recipient-specific data record a request routine has to be implemented neither on the side of the data provider nor the portal server operator. On the contrary it requires, on account of the automatic hyperlink recognition and manipulation, not the least bit of assistance by the data provider or the portal operator

Rather, the hyperlink recognition and manipulation device as well as the request routine generator can be provided by the operator of the central information server and independently from the data provider and the portal server. It further proves to be advantageous that also data e-mails that were present in an information system of the same kind prior to the implementation of the current invention can, in the case of their future presentation via the particular portal server—by means of corresponding recognition and modification of hyperlinks contained therein—, benefit from the system according to the invention whose aim is the determination of data recipient-specific data records.

For the automatic recognition of hyperlinks in the data e-mails, for the purpose of the automatic manipulation of them and for the purpose of the implementation of a, in respective individual cases, automatically initiated request routine including the subsequent redirection to the URL originally linked with the hyperlink, the person skilled in the art has at his disposal the methods that so far are known from prior art (compare for example EP 0889418 A2, W001/03001 Al and US 2004/0083428 Al). The effort for the determination of the desired data recipient-specific data record is minimal for all system participants; the provided means within the system according to the invention for the determination of the desired data recipient-specific data record are arbitrarily scalable and require, even in the event of the participation of new data providers and/or portal servers, no modification.

The system according to the invention therefore offers the possibility for the acquisition of valuable data records of potential parties interested in the special offers of different data providers. The determined data recipient-specific data records are furthermore not only of interest to the data providers but also to the portal operators. The operator of the central information server, who determines the data recipient-specific data records within the framework of the system according to the invention, can make these data records—particularly for a fee—then available to the data provider and/or portal server operators.

In a first advantageous embodiment of the system according to the invention, provision is made that the data recipient-specific data record that is to be determined within the framework of the request routine contains the name and the address of the data recipient. To the data providers and/or portal operators can therefore be conveyed contact information for parties that are potentially interested in their offerings or are accessing special offers via their portal server—and this even though the data contents that were originally linked in the data e-mails were freely accessible. Likewise it is of an advantage if the data recipient-specific data record contains, in reference to the most simple means of establishing contact, —either in addition or alternatively—the e-mail address of the data recipient.

The request routine that was initiated as a result of the selection of the link, after the manipulation according to the invention of said originally present link, does not have to be limited to a pure request routine for the determination of the data recipient-specific data record, but can encompass, as the case may be, additionally an interaction routine. In the context of the request routine it can for example be provided that the data recipient is only redirected to the originally linked URL after the obligatory conclusion of a sale or a subscription. It is therefore the opportunity created to make internet content that is freely accessible by another path available only after the conclusion of a subscription or for a one-time fee. In this context it is of an advantage if in the manipulated hyperlinks the originally linked URL is not recognizable in plain text.

It is particularly preferred in the context of a system according to the invention that the data recipient is requested to enter the data recipient-specific data record—such as for example through the provision of a form to be filled out—in the context of the implementation of the request routine. Experience particularly from the internet offerings, which require registration, from the so-called B2B area have shown that a high percentage (often 80% or more) of the data recipients with serious interest in special offers enter in so doing truthful information, so that one can assume a high yield of usable data recipient-specific data sets in this case. The willingness to pay a fee is also increased in the context of the offer of highly specialized content. The increased quota of data recipients who are willing to provide information and willing to pay is actually also due to the circumstance that the data recipients, via the portal server, become aware of an initially anonymous and complete view of the data e-mails of the data provider; only data recipients demonstrating a certain basic interest will select or click a hyperlink within the data e-mail, whereupon only then the request routine is triggered.

For the detection of falsely entered data sets the address verification algorithms known insofar are available for which for example an indicated address can be checked in regard to its plausibility or accuracy through a comparison of zip codes and other address fields (such as the residence or the street that is to be provided) with commonly available data sets. Also for e-mail addresses there exist corresponding algorithms for the detection of obviously incorrect entries, for example those not following the common form standard.

In certain cases the provider-specific data record can, according to an additional preferred embodiment of the invention, also be determined automatically, meaning without further assistance from the data recipient. Such an automatic determination of the data recipient-specific data record in the context of the request routine is to be implemented particularly when the data recipient, subject to entering of the data concerning the data recipient-specific data record with the central information server or the portal server, is registered and correspondingly identifiable. This of course is only possible if the data recipient who is selecting the respective hyperlink within the data e-mail is correspondingly registered or logged in, for which in the case of the present information system provision can be optimally made. For the purpose of providing, on the side of the data recipient, these data that are to be determined automatically, the person skilled in the art has available, in the case of a user registration, the insofar known mechanisms that can rely on for example the utilization of a “cookie” that was deposited in the temporary internet memory of the data recipient. It is preferred in the context of a system according to the invention to initially make the attempt within the context of the request routine and for reasons of user friendliness to determine the desired data recipient-specific data record automatically and to prompt the data recipient only then for the input of the corresponding data if these cannot be determined automatically. The request routine can thereby preferably also be designed such that, if only a part of the desired data can be determined automatically, these fields are already filled in the case of a corresponding input request. In addition the data recipient can, in the context of a system according to the invention, in the case of the automatic determination of the data record that concerns him be prompted, prior to his redirection to the URL that was originally linked in the data e-mail by means of the hyperlink, for the confirmation of the automatically determined data.

The system according to the invention can be implemented such that the manipulated hyperlink refers to a URL, which is linked with a dynamically generated web page of the web interface unit, of the central information server, whereby on the dynamically generated web page corresponding request means for the determination of the data recipient-specific data record (for example in form of an automatically executable script for the determination of already present data and/or for the generation of corresponding input forms) and corresponding redirection means for the purpose of redirecting the data recipient to the original URL after the successful completion of the request routine are provided. The URL that was originally linked with the—not manipulated—hyperlink is thereby preferably transferred as part of the manipulated hyperlink to the redirection means of the dynamically generated web page.

In an advantageous embodiment of the present invention it can be provided that the data providers and/or the operators of the portal server can determine themselves whether hyperlinks within data e-mails that were brought into the system by them or data e-mails that are represented via their portal server should be manipulated by the hyperlink recognition- and manipulation device for the triggering of the request routine, or not. Namely, not every data provider or portal operator is interested in the data recipient-specific data set that can be determined by the system according to the invention. Likewise it could for example be stipulated by the data providers that the hyperlinks in their data e-mails should only be correspondingly manipulated when these are presented to a data recipient via a special portal server. One and the same data e-mail can therefore be for example presented via different portal servers once with and once without manipulated hyperlinks. The data providers can for example also be given the opportunity within the context of the system according to the invention to make this selection for different hyperlinks within one data e-mail separately, for example by means of defining certain key words, which can be usable in the source text of the data e-mail, and by means of which the hyperlink recognition and manipulation device is controllable.

In order to establish the necessary requirements for the structured collection of the data recipient-specific data records, provision is made according to a further preferred embodiment form of the invention that the central information server furthermore features a correlation data record generating unit by means of which a correlation data record can be automatically generated within which the data recipient-specific data set that was generated in the context of the request routine is linked with at least one of the following data:
Identity of the data provider of the data e-mail within which the manipulated hyperlink was located that the data recipient clicked on,
Identity of the portal server via which the respective data e-mail was presented,
Identity of the respective data e-mail in which the automatically recognized and manipulated hyperlink was located,
URL to which the original hyperlink referred.

As far as individual portal servers offer several separate sub-offerings to differently selected data e-mails of the central information server, it can also be of an advantage when—besides the identity of the portal server—the identity of the corresponding sub-offering is also incorporated into the correlation data record. Likewise date and/or time of the selection of the manipulated hyperlink by the data recipient can be of interest.

For the purposes of a most universal data collection all of the previously mentioned data are preferably gathered in the correlation data record and collected in an automatically generated data bank for further processing.

Besides the previously described system the present invention concerns also a method for the determination of a data recipient-specific data record in an internet-based information system that encompasses the following procedure steps:
Provision of a central information server with an e-mail interface unit, a web interface unit and a memory installation that encompasses at least one offering supply memory unit;
Provision of a plurality of portal servers that each have at their disposal a web interface unit and can be connected with the web interface unit of the central information server;
Transmission of data e-mails, containing data provider-specific data via a plurality of data processing installations that each are associated with a data provider, to each at least one data provider-specific e-mail address of the central information server;
Automatic storage of the data e-mails that arrive at the central information server in the supply offering memory unit;
Facilitating the establishment of connections between a plurality of data processing installations, which are associated each with one data recipient and have a web interface at their disposal, and the central information server by means of a link of the portal server respectively selected by the data recipient.
Automatic selection, which depends on the identity of the respective portal server, of, and access release to, data e-mails that are stored in the supply offering memory unit, whereby hyperlinks present in the data e-mails are automatically recognized and manipulated in such a manner that a selection of the manipulated hyperlink by the data recipient triggers initially a request routine for the determination of a data recipient-specific data record, whereby the data recipient is only then redirected to the URL of the hyperlink that was originally present in the data e-mail when the request routine is successfully completed.
Call-up of the data e-mails that were selected, released, and are provided with manipulated hyperlinks by the plurality of data recipients via the World Wide Web.

It is understood that all of the previously, in the context of the system according to the invention, explained advantages and preferred embodiments correspondingly apply also to the method according to the invention so that insofar, for the purposes of avoiding repetitions, the previous statements are referred to.

Furthermore the applicant has realized that the technical teaching according to the invention is not cogently limited to the previously explained system for the selective presentation of data e-mails. Rather it can concern, within the context of the invention according to claim 8 and in the case of the data that are made accessible to the data recipient via a plurality of portal servers of a plurality of data providers, data contents in general (therefore not only in the form of e-mails or e-mail file attachments). In this context one should think particularly of—provided by means of the information server—the—banner advertising which is either linked with a hyper link or contained within one. In this case also can a request routine be triggered, in the context of the invention and subsequent to automatic recognition and manipulation of the hyperlinks present in the data contents (for example advertising banners), for the determination of data recipient-specific data record as a result of the selection of the hyperlink.

In what follows the present invention is further explained on the basis of an embodiment example illustrated in the drawing, whereby the presented system serves the purpose of informing potential customers of the current offerings of retail businesses.

The system encompasses a central information server 1, two data processing installations 2, of which the data processing installation 2x is associated with a (data-) provider X and the data processing installation 2y is associated with a (data-) provider Y, as well as three portal servers 3, of which the portal server 3A is thematically aligned with the subject area A, the portal server 3B is with the subject area B and the portal server 3C is with the subject area C.

The provider X operates in the business areas A and B, the provider Y on the other hand in the business areas B and C.

The central information server encompasses an e-mail interface unit 4 by means of which the provider data processing installations 2x and 2y can communicate via e-mail interfaces 5x or 5y that are associated respectively each with them. The providers X and Y are allocated thereby each two e-mail addresses, namely the provider X the addresses 4xA and 4xB, and the provider Y the addresses 4yB and 4yC. In this manner the provider X aims his data e-mails, which contain offerings concerning his business area A, at the e-mail address 4xA and his data e-mails, which contain offerings concerning his business area B, at the e-mail address 4xB; and the provider Y aims his data e-mails, which contain offerings concerning his business area B, at the e-mail address 4yB and his data e-mails, which contain offerings concerning his business area C, at the e-mail address 4yC.

The central information server 1 encompasses a memory installation 6 with an offering supply memory unit 7, in which the data e-mails 8 that contain the respectively current offerings of the providers that are connected are stored, namely the data e-mails 8xA, 8xB, 8yB, 8C at hand. During the arrival of the corresponding data e-mails, as the case may be, no longer current data e-mails of the particularly provider (X, Y) can be moved from the offering supply memory unit 7 to an archive 9 that is part of the memory installation 6.

The central information server 1 features furthermore a web interface unit 10 via which the portal servers 3 have access to the central information server 1 via web interface units 11, which themselves are each assigned. Each of the three portal servers 3 can thereby be connected via a link on his internet offering with the central information server 1. The links on the individual portal servers are however linked with different URls. The portal server 3A is therefore connected with a URL 10A, associated with which is a web page 12A in which the data e-mail 8xA—after it was, as the case may be, modified according to the criteria described further below—is embedded. The portal server 3B is linked with a URL 10B associated with which is a web page 12B in which a list with the (modified, as the case may be) data e-mails 8xB and 8yB is embedded. And the portal server 3C is linked with a URL 10C associated with which is a web page 12C in which the, as the case may be, modified data e-mail 8yC is embedded. In this manner a selection device 13 is created in the sense that any potential data or offering recipient E who visits, using the web browser 14 of his PC 15 that has an internet access at its disposal, the internet presence or the home page 16A of the portal server 3A and is redirected through clicking of the link that is embedded there to the central information server 1, can view exclusively the web page 12A with the (modified) data e-mail 8xA, whereas he, if he is redirected through clicking of the link that is embedded on the home page 16B of the portal server 3B to the central information server 1, can view exclusively the web page 12B with the (modified) data e-mails 8xB and 8yB, etc.

Hereby it is apparent that it is not cogently required that the data recipient (E) clicks or selects, for the purposes of viewing the respective web page 12A, 12B, 12C, a corresponding link within the internet offering 16A, 16B, and 16C of the respective portal server 3A, 3B, or 3C; rather the respective web page 12A, 12B, 12C of the central information server 1 can also be directly integrated by appropriate linking (dynamically) into the internet offering 16A, 16B, and 16C of the respective portal server 3A, 3B, 3C and thereby be for example indicated in a certain frame of the web page or at another suitable position within the web page 16A, 16B, or 16C of the portal server 3A, 3B, 3C.

The web pages 12A, 12B, and 12C are constructed according to a unifying scheme so that the data recipient can move and orient himself within them without extensive practice.

The web pages 12 do not, as was already explained, contain in each case the respective data e-mails 8 in exactly the form in which they were transmitted by the respective data providers X, Y to the e-mail interface unit 4 of the central information server 1. The central information server 1 has at its disposal, in particular, a hyperlink recognition and manipulation device 17, by means of which hyperlinks 18 that are present within the data e-mails 8 can be automatically recognized and manipulated. In the case therefore where a corresponding manipulation is desired by the data provider Y, the hyperlink that is present in the data e-mail 8yC and recognized automatically therein by the hyperlink recognition and manipulation device 17 is automatically manipulated by said unit to a new hyperlink 19 that is modified in such a manner that the data recipient E, while clicking of the manipulated hyperlink 19, is no longer immediately redirected to the URL connected with the original hyperlink 18, but that initially a request routine 20 is triggered.

In the context of—dynamically generated by request routine generator—request routine 20 a data recipient-specific data record 21 is determined, which contains besides the name and the address of the data recipient E also his e-mail address. This data record 21 is thereby determined by the request routine 20 either automatically (if the corresponding data are available for example in the part of the internet cache of the data recipient E that is accessible to the central information server 1) or the data recipient E is himself prompted—by means of the provision of the corresponding form—regarding the input of the respective information. After successful determination of the data record 21 a redirection routine 22 is initiated by means of which the data recipient E is redirected to the destination of the hyperlink 18 that was present in the data e-mail 8yC.

The data record 21 is appended to, subsequent to its determination, in a correlation data record generating unit 23 of the central information server 1 with additional data (for example with the identity of the data e-mail that contains the hyperlink and the identity of the portal server) to constitute a correlation data record 24 and is stored in a data bank 25 within the memory installation 6 for further processing. These data can be then be made accessible to the data providers and/or portal server operators.

1. Internet-based information system for selectively presenting data e-mails (8) from a plurality of data providers (X, Y), said presentation being able to be called up for a plurality of data recipients (E), comprises
a central information server (1) having an e-mail interface unit (4), a web interface unit (10), a memory device (6), which has at least one offering supply memory unit (7) for storing data e-mails (8) from the data providers (X, Y), and a selection device (13),
a plurality of data processing installations (2), which are respectively associated with a provider (X, Y) and which have an e-mail interface (5_{X}, 5_{Y}) which is capable of communicating with at least one provider-specific e-mail address (4_{X,A}, 4_{X,B}, 4_{Y,B}, 4_{Y,C}) for the e-mail interface unit (4) of the central information server (1),
a plurality of portal servers (3), which respectively have a web interface (11_{A}, 11_{B}, 11_{C}) and which can be connected to the web interface unit (10) of the central information server (1),
whereby the portal servers (3) have access to specific data e-mails (8xA, 8xB, 8yB, 8yC) that are stored in the offering supply memory unit (7) and are automatically determined by the selection installation (13) depending on the identity of the respective portal server (3A, 3B, 3C) and can then present these via a link to a homepage (16A, 16B, 16C),
characterized in that the central information server (1) furthermore features a hyperlink recognition and manipulation device (17), by means of which hyperlinks (18) present within the data e-mails (8) can be automatically recognized and manipulated in such a way that a selection of a hyperlink (19), which was presented and manipulated in a data e-mail (8) that was presented via a portal server (3) initially triggers a request routine (20) for the determination of data recipient-specific data record (21), whereby the data recipient (E) is only then redirected to the URL of the hyperlink (18) that was originally present in the data e-mail when the request routine (20) is successfully completed.

2. Internet-based information system according to claim 1, characterized in that the data recipient-specific data record (21) contains the name and the address of the data recipient.

3. Internet-based information system according to claim 1, characterized in that the data recipient-specific data record (21) contains the e-mail address of the data recipient.

4. Internet-based information system according to claim 1, characterized in that the data recipient (E) is prompted in the context of the implementation of the request routine (20) for the input of the data recipient-specific data record (21).

5. Internet-based information system according to claim 1, characterized in that the request routine (20) determines the data recipient-specific data record (21) automatically in the case where the data recipient (E), subject to entry of the data concerning the data recipient-specific data record (E), is registered or correspondingly identifiable at the central information server (E) or the portal server (3).

6. Internet-based information system according to claim 1, characterized in that the central information server (1) features furthermore a correlation data set generating unit (23) by means of which a correlation data record (24) can be automatically generated in which the data recipient-specific data record (21) that was determined in the context of the request routine can be linked with at least one of the following data:
Identity of the data provider of the data e-mail in which the hyperlink that was clicked and manipulated by the data recipient was located,
Identity of the portal server by means of which the corresponding data e-mail was presented,
Identity of the respective data e-mail in which the automatically recognized and manipulated hyperlink was located,
URL to which the original hyperlink referred.

7. Method for the determination of a data recipient-specific data record in an internet-based information system encompassing the following procedure steps:
Provision of a central information server (1) with an e-mail interface unit (4), a web interface unit (10) and a memory installation (6) that encompasses at least one offering supply memory unit (7);
Provision of a plurality of portal servers (3) that each have at their disposal a web interface unit (3) and can be connected with the web interface unit (11) of the central information server ( );
Transmission of data e-mails (8), containing data provider-specific data via a plurality of data processing installations (2) that each are associated with a data provider (X, Y), to each at least one data provider-specific e-mail address (4xA, 4xB, 4yC, 4xC) of the central information server (1);
Automatic storage of the data e-mails (8) that arrive at the central information server (1) in the supply offering memory unit (7);
Facilitating the establishment of connections between a plurality of data processing installations (15), which are associated each with one data recipient (E) and have a web interface (14) at their disposal, and the central information server (1) by means of a link of the portal server (3) respectively selected by the data recipient;
Automatic selection, which depends on the identity of the respective portal server (3), of, and access release to, data e-mails (8) that are stored in the supply offering memory unit (7), whereby hyperlinks (18) present in the data e-mails (8) are automatically recognized and manipulated in such a manner that a selection of the manipulated hyperlink (19) by the data recipient (E) triggers initially a request routine (20) for the determination of a data recipient-specific data record (21), whereby the data recipient (E) is only then redirected to the URL of the hyperlink (18) that was originally present in the data e-mail (8) when the request routine (20) is successfully completed;
Call-up of the data e-mails (8) that were selected, released, and are provided with manipulated hyperlinks (19) by the plurality of data recipients (E) via the World Wide Web.

8. Internet-based information system for the purpose of the selective presentation of data contents (8), which can be called-up by a plurality of data recipients (E), of a plurality of data providers (X, Y), encompassing
a central information server (1) with a web interface unit (10), a memory installation (6) which features at least one data content memory unit (7) for the purpose of storing the data contents (8) that are provided by the data providers (X, Y), and a selection device (13),
plurality of portal servers (3) that each control a web interface (11) and can be connected with the web interface unit (10) of the central information server (1),
whereby the portal servers (3) have access to specific data contents (8) that are stored in the data content memory unit (7) of the central information server (1) and can present these on their web page (16),
characterized in that,
the central information server furthermore features a hyperlink recognition and manipulation device (17), by means of which hyperlinks (18) present within the data contents (8) or hyperlinks that linked with the data contents can be automatically recognized and manipulated in such a way that a selection of a hyperlink (19), which was presented and manipulated in a data e-mail (8) that was presented via a portal server (3) initially triggers a request routine for the determination of data recipient-specific data record (21), whereby the data recipient (E) is only then redirected to the URL that was originally present in the data content (8) when the request routine is successfully completed.
